(19) United States
(12) Patent Application Publication
(10) Pub. No.: US 2015/0091863 A1
(43) Pub. Date: Apr. 2, 2015

(54) DEVICE INTEGRATING CAPACITIVE TOUCH AND RESISTIVE TOUCH AND OPERATION METHOD THEREOF

(71) Applicant: SENTELIC CORPORATION, Taipei City (TW)

(72) Inventors: Jao-Ching Lin, Taipei City (TW); Wen-Ting Lee, Taipei City (TW); Chung-Yi Shen, Taipei City (TW)

(21) Appl. No.: 14/501,045

(22) Filed: Sep. 30, 2014

(30) Foreign Application Priority Data
Sep. 30, 2013 (TW) 102135370

(51) Int. Cl. G06F 3/044; G06F 3/045; G06F 3/041

(52) U.S. Cl. CPC G06F 3/044; G06F 3/0416; G06F 3/045
USPC 345/174

(57) ABSTRACT

A device integrating capacitive touch and resistive touch includes a first sensing layer, a second sensing layer, and a processing unit. The first sensing layer includes a plurality of sensing units, wherein the plurality of sensing units are insulated from each other. The second sensing layer installed below the first sensing layer includes a plurality of electrodes. The processing unit is used for charging the first sensing layer, detecting capacitance variation of the plurality of sensing units, and determining a position of at least one first touch point according to the capacitance variation of the plurality of sensing units in a capacitive touch mode; and charging the first sensing layer, detecting resistance variation of the plurality of electrodes, and determining a position of at least one second touch point according to the resistive variation of the plurality of electrodes in a resistive touch mode.

### BACKGROUND OF THE INVENTION

1. Field of the Invention

The present invention relates to a device integrating capacitive touch and resistive touch and an operation method thereof, and particularly to a device integrating capacitive touch and resistive touch and an operation method thereof that can utilize a first sensing layer to support a resistive touch function of a second sensing layer.

2. Description of the Prior Art

A capacitive touch panel has multi-touch and better operational sense advantages, so the capacitive touch panel gradually substitutes for a resistive touch panel. Although the capacitive touch panel has the multi-touch and the better operational sense advantages, the capacitive touch panel cannot locate precisely like the resistive touch panel (e.g. a touch point position corresponding to a nib or a nail). Therefore, the prior art has provided a touch panel having capacitive touch and resistive touch. But, the prior art directly superposes a capacitive touch panel on a resistive touch panel to form a touch panel integrating capacitive touch and resistive touch. Thus, the touch panel integrating capacitive touch and resistive touch provided by the prior art not only has a complicated structure, but can not also reduce cost of the touch panel.

### SUMMARY OF THE INVENTION

An embodiment provides a device integrating capacitive touch and resistive touch. The device includes a first sensing layer, a second sensing layer, and a processing unit. The first sensing layer includes a plurality of sensing units, wherein the plurality of sensing units are insulated from each other. The second sensing layer is installed below the first sensing layer including a plurality of electrodes. The processing unit is used for charging the first sensing layer, detecting capacitance variation of the plurality of sensing units, and determining a position of at least one first touch point according to the capacitance variation of the plurality of sensing units in a capacitive touch mode; and charging the first sensing layer, detecting resistance variation of the plurality of electrodes, and determining a position of at least one second touch point according to the resistance variation of the plurality of electrodes in a resistive touch mode.

Another embodiment provides an operation method of a device integrating capacitive touch and resistive touch. The device includes a first sensing layer, a second sensing layer, and a processing unit, wherein the first sensing layer includes a plurality of sensing units, and the second sensing layer includes a plurality of electrodes. The operation method includes the processing unit charging the first sensing layer when the device is in a capacitive touch mode; the processing unit detecting capacitance variation of the plurality of sensing units; determining a position of at least one first touch point the processing unit according to the capacitance variation of the plurality of sensing units; and the processing unit generating at least one first corresponding control signal according to the position of the at least one first touch point.

Another embodiment provides an operation method of a device integrating capacitive touch and resistive touch. The device includes a first sensing layer, a second sensing layer, and a processing unit, wherein the first sensing layer includes a plurality of sensing units, and the second sensing layer includes a plurality of electrodes. The operation method includes the processing unit charging the first sensing layer when the device is in a resistive touch mode; the processing unit detecting resistance variation of the plurality of electrodes; the processing unit determining a position of at least one second touch point according to the resistance variation of the plurality of electrodes; and the processing unit generating at least one second corresponding control signal according to the position of the at least one second touch point.

Another embodiment provides an operation method of a device integrating capacitive touch and resistive touch. The device includes a first sensing layer, a second sensing layer, and a processing unit, wherein the first sensing layer includes a plurality of sensing units, and the second sensing layer includes a plurality of electrodes. The operation method includes the processing unit charging the second sensing layer when the device is in a resistive touch mode; the processing unit detecting resistance variation of the plurality of sensing units; the processing unit determining a position of at least one third touch point according to resistance variation of the plurality of sensing units; and the processing unit generating at least one third corresponding control signal according to the at least one third touch point.

The present invention provides a device integrating capacitive touch and resistive touch and an operation method thereof. Because the device and the operation method utilize a first sensing layer (corresponding to a capacitive touch function) to support a resistive touch function of a second sensing layer in a resistive touch mode, the present invention can simultaneously have the capacitive touch function and the resistive touch function by only two sensing layers (the first sensing layer and the second sensing layer). In addition, compared to the prior art, the present invention further has advantages as follows: first, because the present invention only has the first sensing layer to correspond to the capacitive touch function, the first sensing layer does not need a conductance bridge; second, because the present invention only has the two sensing layers and does not have an alignment problem between electrode units of the two sensing layers, the present invention can tolerate greater alignment shift; and third, because the present invention only has the two sensing layers, the present invention has higher transmittance and simpler processes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a device integrating capacitive touch and resistive touch according to an embodiment.

FIG. 2 is a diagram illustrating the first sensing layer.

FIG. 3 is a diagram illustrating the second sensing layer.

FIG. 4 is a diagram illustrating sensing units according to another embodiment.

FIG. 5 is a flowchart illustrating an operation method of a device integrating capacitive touch and resistive touch according to another embodiment.

FIG. 6 is a flowchart illustrating an operation method of a device integrating capacitive touch and resistive touch according to another embodiment.

### DETAILED DESCRIPTION

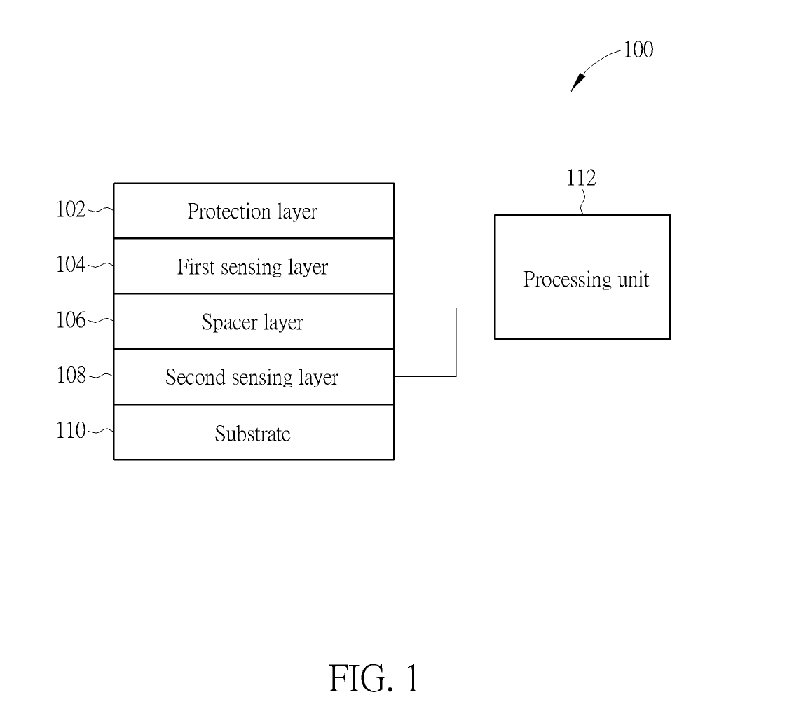

Please refer to FIG. 1. FIG. 1 is a diagram illustrating a device 100 integrating capacitive touch and resistive touch according to an embodiment. The device 100 includes a protection layer 102, a first sensing layer 104 which has a capacitive touch function (that is, one sensing layer (the first sensing layer 104) has the capacitive touch function), a spacer layer 106, a second sensing layer 108 which has a resistive touch function (that is, one sensing layer (the second sensing layer 108) has the resistive touch function), a substrate 110, and a processing unit 112, wherein the protection layer 102 is glass, a polymethylmethacrylate (PMMA), a polyethylene terephthalate (PET) plastic membrane, or a polyethylene naphthalate (PEN) plastic membrane. In addition, the substrate 110 is an anti-oxidation layer. But, the present invention is not limited to the substrate 110 being an anti-oxidation layer. As shown in FIG. 1, the first sensing layer 104 and the second sensing layer 108 electrically connected to the processing unit 112. As shown in FIG. 1, the protection layer 102 is installed above the first sensing layer 104; the spacer layer 106 installed between the first sensing layer 104 and the second sensing layer 108; the second sensing layer 108 is installed below the spacer layer 106; and the substrate 110 installed below the second sensing layer 108.

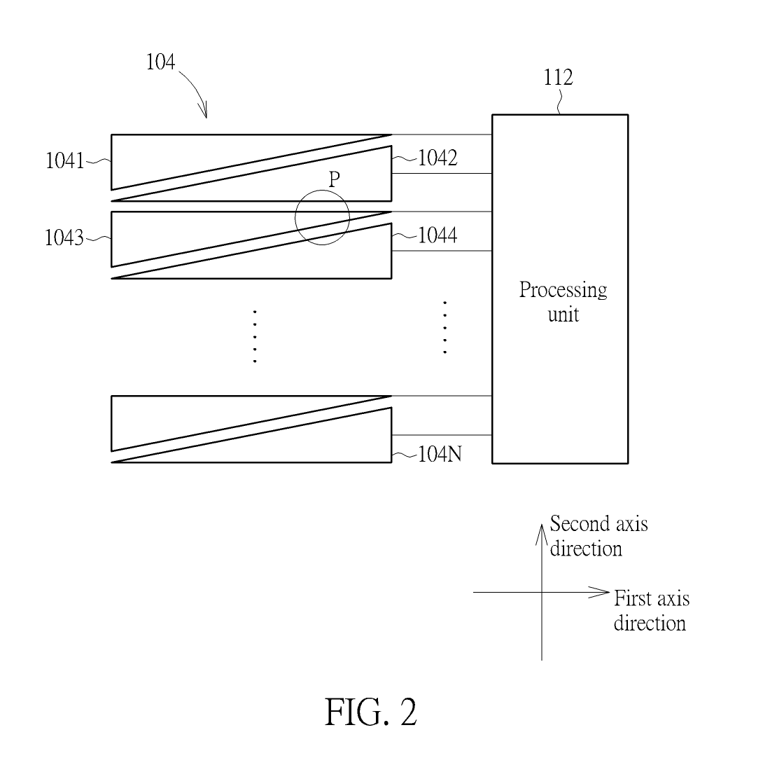

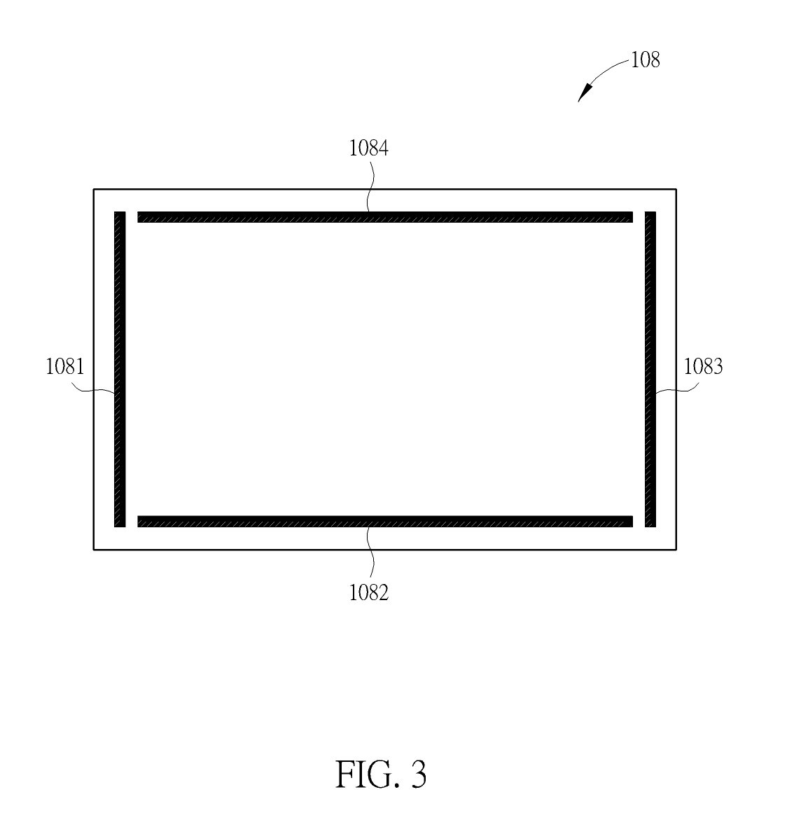

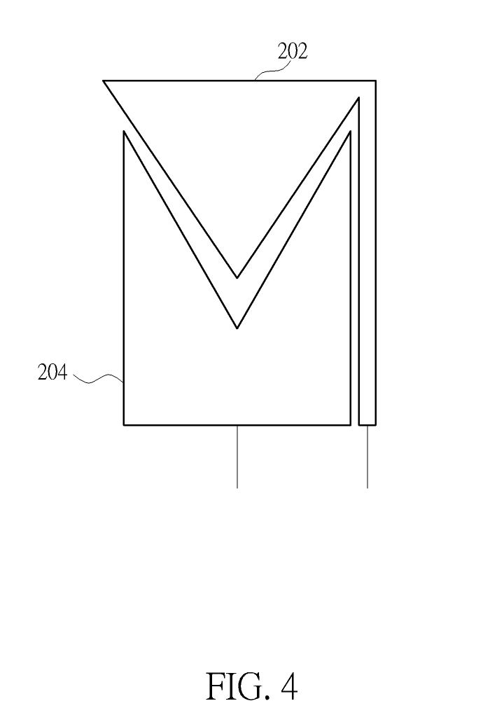

Please refer to FIG. 2 and FIG. 3. FIG. 2 is a diagram illustrating the first sensing layer 104, and FIG. 3 is a diagram illustrating the second sensing layer 108. As shown in FIG. 2, the first sensing layer 104 includes a plurality of sensing units 1041-104N, wherein the first sensing layer 104 is glass, and the plurality of sensing units 1041-104N are transparent conductive glass (e.g. indium tin oxide (ITO) or fluorine-doped tin Oxide (FTO)) electroplated on a surface of the glass. In addition, the plurality of sensing units 1041-104N are insulated from each other, N is a positive integer greater than 1, a side of each sensing unit of the plurality of sensing units 1041-104N parallel to a first axis direction is greater than a side of the sensing unit of the plurality of sensing units 1041-104N parallel to a second axis direction, and the first axis direction is perpendicular to the second axis direction. As shown in FIG. 2, each sensing unit of the plurality of sensing units 1041-104N is a right triangle. But, the present invention is not limited to each sensing unit of the plurality of sensing units 1041-104N being a right triangle. Please refer to FIG. 4. FIG. 4 is a diagram illustrating sensing units 202, 204 according to another embodiment. As shown in FIG. 4, each two corresponding sensing units of the plurality of sensing units 1041-104N can be replaced with the sensing units 202, 204. For example, the sensing units 1041, 1042 can be replaced with the sensing units 202, 204. In addition, as shown in FIG. 2, a wire coupled to each sensing unit of the plurality of sensing units 1041-104N is extended to the processing unit 112 along the first axis direction. But, the present invention is not limited to an arrangement pattern of the plurality of sensing units 1041-104N shown in FIG. 2. As shown in FIG. 3, the second sensing layer 108 includes a plurality of electrodes (e.g. 4 electrodes 1081-1084). But, the present invention is not limited to the second sensing layer 108 including the 4 electrodes 1081-1084. That is to say, the second sensing layer 108 can include 5 electrodes, 6 electrodes, or more electrodes.

Because the device 100 integrates capacitive touch and resistive touch, the processing unit 112 can execute a capacitive touch mode and a resistive touch mode in turn. When the device 100 is in a capacitive touch mode, the processing unit 112 is used for charging the sensing unit 1041-104N of the first sensing layer 104, detecting capacitance variation of the sensing unit 1041-104N, and determining a position of at least one first touch point according to the capacitance variation of the sensing unit 1041-104N. For example, the processing unit 112 can obtain an X coordinate corresponding to a touch point P according to the capacitance variation of the sensing unit 1042-1044 in the first axis direction corresponding to the touch point P shown in FIG. 2, and detect the capacitance variation of the sensing unit 1042-1044 in the second axis direction corresponding to the touch point P to obtain a Y coordinate of the touch point P, wherein a range of the touch point P can correspond to a nib of a pen or a finger of a user. In addition, after the processing unit 112 determines the position of the at least one first touch point, the processing unit 112 can generate at least one first corresponding control signal according to the position of the at least one first touch point. For example, after the processing unit 112 determines the position of the at least one first touch point, the processing unit 112 can generate the at least one first corresponding control signal to a first predetermined application program according to the position of the at least one first touch point. Then, the first predetermined application program can execute a corresponding operation according to the at least one first corresponding control signal.

When the device 100 is in a resistive touch mode, the processing unit 112 is used for charging the sensing unit 1041-104N of the first sensing layer 104 in turn or simultaneously, detecting resistance variation of the 4 electrodes 1081-1084 of the second sensing layer 108, and determining a position of at least one second touch point according to the resistance variation of the 4 electrodes 1081-1084. After the processing unit 112 determines the position of the at least one second touch point, the processing unit 112 can generate at least one second corresponding control signal according to the position of the at least one second touch point. For example, after the processing unit 112 determines the position of the at least one second touch point, the processing unit 112 can generate at least one second corresponding control signal to a second predetermined application program according to the position of the at least one second touch point. Then, the second predetermined application program can execute a corresponding operation according to the at least one second corresponding control signal.

In addition, when the device 100 is in the resistive touch mode, the processing unit 112 is used for charging the 4 electrodes 1081-1084 of the second sensing layer 108, detecting resistance variation of the sensing unit 1041-104N of the first sensing layer 104, and determining a position of at least one third touch point according to the resistance variation of the sensing unit 1041-104N. After the processing unit 112 determines the position of the at least one third touch point, the processing unit 112 can generate at least one third corresponding control signal to a third predetermined application program according to the position of the at least one third touch point. Then, the third predetermined application program can execute a corresponding operation according to the at least one third corresponding control signal.

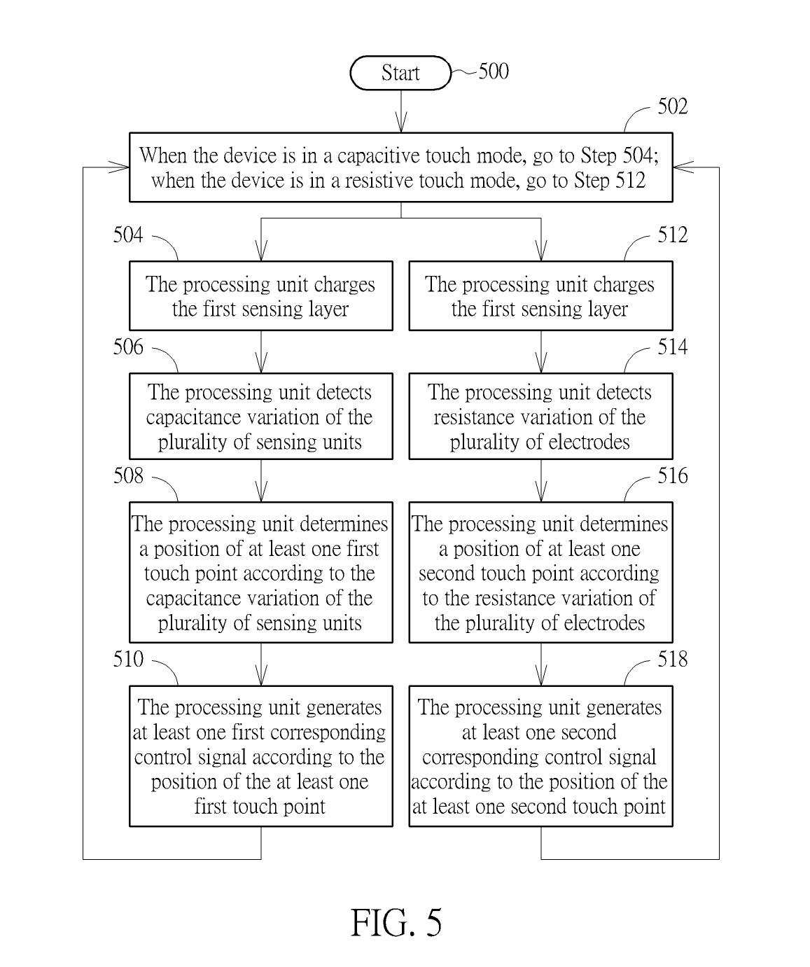

Please refer to FIG. 1, FIG. 2, FIG. 3, and FIG. 5. FIG. 5 is a flowchart illustrating an operation method of a device integrating capacitive touch and resistive touch according to another embodiment. The method in FIG. 5 is illustrated using the device 100 in FIG. 1. Detailed steps are as follows:

Step 500: Start.

Step 502: When the device 100 is in a capacitive touch mode, go to Step 504; when the device 100 is in a resistive touch mode, go to Step 512.

Step 504: The processing unit 112 charges the first sensing layer 104.

Step 506: The processing unit 112 detects capacitance variation of the plurality of sensing units 1041-104N.

Step 508: The processing unit 112 determines a position of at least one first touch point according to the capacitance variation of the plurality of sensing units 1041-104N.

Step 510: The processing unit 112 generates at least one first corresponding control signal according to the position of the at least one first touch point, go to Step 502.

Step 512: The processing unit 112 charges the first sensing layer 104.

Step 514: The processing unit 112 detects resistance variation of the plurality of electrodes.

Step 516: The processing unit 112 determines a position of at least one second touch point according to the resistance variation of the plurality of electrodes.

Step 518: The processing unit 112 generates at least one second corresponding control signal according to the position of the at least one second touch point, go to Step 502.

In Step 510, after the processing unit 112 determines the position of the at least one first touch point, the processing unit 112 can generate the at least one first corresponding control signal according to the position of the at least one first touch point. For example, after the processing unit 112 determines the position of the at least one first touch point, the processing unit 112 can generate the at least one first corresponding control signal to a first predetermined application program according to the position of the at least one first touch point. Then, the first predetermined application program can execute a corresponding operation according to the at least one first corresponding control signal. In Step 518, after the processing unit 112 determines the position of the at least one second touch point, the processing unit 112 can generate the at least one second corresponding control signal to a second predetermined application program according to the position of the at least one second touch point. Then, the second predetermined application program can execute a corresponding operation according to the at least one second corresponding control signal.

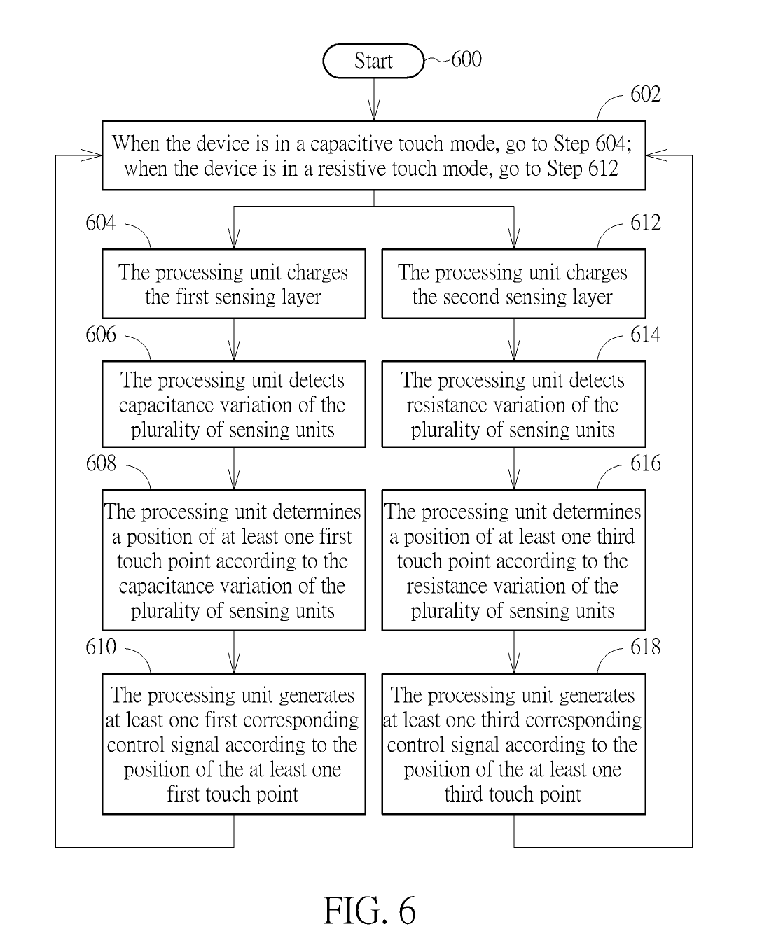

Please refer to FIG. 1, FIG. 2, FIG. 3, and FIG. 6. FIG. 6 is a flowchart illustrating an operation method of a device integrating capacitive touch and resistive touch according to another embodiment. The method in FIG. 6 is illustrated using the device 100 in FIG. 1. Detailed steps are as follows:

Step 600: Start.

Step 602: When the device 100 is in a capacitive touch mode, go to Step 604; when the device 100 is in a resistive touch mode, go to Step 612.

Step 604: The processing unit 112 charges the first sensing layer 104.

Step 606: The processing unit 112 detects capacitance variation of the plurality of sensing units 1041-104N.

Step 608: The processing unit 112 determines a position of at least one first touch point according to the capacitance variation of the plurality of sensing units 1041-104N.

Step 610: The processing unit 112 generates at least one first corresponding control signal according to the position of the at least one first touch point, go to Step 602.

Step 612: The processing unit 112 charges the second sensing layer 108.

Step 614: The processing unit 112 detects resistance variation of the plurality of sensing units 1041-104N.

Step 616: The processing unit 112 determines a position of at least one third touch point according to the resistance variation of the plurality of sensing units 1041-104N.

Step 618: The processing unit 112 generates at least one third corresponding control signal according to the position of the at least one third touch point, go to Step 602.

A difference between the embodiment in FIG. 6 and the embodiment in FIG. 5 is that in Step 612, the processing unit 112 charges the second sensing layer 108; in Step 614, the processing unit 112 detects the resistance variation of the plurality of sensing units 1041-104N; and in Step 616, the processing unit 112 determines the position of the at least one third touch point according to the resistance variation of the plurality of sensing units 1041-104N. In addition, subsequent operational principles of the embodiment in FIG. 6 are the same as those of the embodiment in FIG. 5, so further description thereof is omitted for simplicity.

To sum up, because the device integrating capacitive touch and resistive touch and the operation method thereof utilize the first sensing layer (corresponding to the capacitive touch function) to support the resistive touch function of the second sensing layer in the resistive touch mode, the present invention can simultaneously have the capacitive touch function and the resistive touch function by only two sensing layers (the first sensing layer and the second sensing layer). In addition, compared to the prior art, the present invention further has advantages as follows: first, because the present invention only has the first sensing layer to correspond to the capacitive touch function, the first sensing layer does not need a conductance bridge; second, because the present invention only has the two sensing layers and does not have an alignment problem between electrode units of the two sensing layers, the present invention can tolerate greater alignment shift; and third, because the present invention only has the two sensing layers, the present invention has higher transmittance and simpler processes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device integrating capacitive touch and resistive touch, the device comprising:
a first sensing layer comprising a plurality of sensing units, wherein the plurality of sensing units are insulated from each other;
a second sensing layer installed below the first sensing layer comprising a plurality of electrodes; and
a processing unit for charging the first sensing layer, detecting capacitance variation of the plurality of sensing units, and determining a position of at least one first touch point according to the capacitance variation of the plurality of sensing units in a capacitive touch mode; and charging the first sensing layer, detecting resistance variation of the plurality of electrodes, and determining a position of at least one second touch point according to the resistance variation of the plurality of electrodes in a resistive touch mode.

2. The device of claim 1, wherein the processing unit is further used for generating at least one first corresponding control signal according to the position of the at least one first touch point, and generating at least one second corresponding control signal according to the position of the at least one second touch point.

3. The device of claim 1, wherein the processing unit is further used for charging the second sensing layer, detecting resistance variation of the plurality of sensing units, and determining a position of at least one third touch point according to the resistance variation of the plurality of sensing units in the resistive touch mode, wherein a range of the position of the at least one third touch point corresponds to a nib of a pen or a finger of a user.

4. The device of claim 3, wherein the processing unit is further used for generating at least one third corresponding control signal according to the position of the at least one third touch point.

5. The device of claim 1, further comprising:
a protection layer installed above the first sensing layer;
a spacer layer installed between the first sensing layer and the second sensing layer; and
a substrate installed below the second sensing layer.

6. The device of claim 5, wherein the protection layer is glass, a polymethylmethacrylate (PMMA), or a transparent polyethylene terephthalate (PET) plastic membrane.

7. The device of claim 1, wherein a side of each sensing unit of the plurality of sensing units parallel to a first axis direction is greater than a side of the sensing unit of the plurality of sensing units parallel to a second axis direction, wherein the first axis direction is perpendicular to the second axis direction.

8. The device of claim 1, wherein a range of the position of the at least one first touch point and a range of the position of the at least one second touch point correspond to a nib of a pen or a finger of a user.

9. The device of claim 1, wherein the first sensing layer has a capacitive touch function and the second sensing layer has a resistive touch function.

10. The device of claim 1, wherein the first sensing layer has one-layer capacitive touch function.

11. The device of claim 1, wherein the second sensing layer has one-layer resistive touch function.

12. An operation method of a device integrating capacitive touch and resistive touch, the device comprising a first sensing layer, a second sensing layer, and a processing unit, wherein the first sensing layer comprises a plurality of sensing units, and the second sensing layer comprises a plurality of electrodes, the operation method comprising:
the processing unit charging the first sensing layer when the device is in a capacitive touch mode;
the processing unit detecting capacitance variation of the plurality of sensing units;
determining a position of at least one first touch point the processing unit according to the capacitance variation of the plurality of sensing units; and
the processing unit generating at least one first corresponding control signal according to the position of the at least one first touch point.

13. An operation method of a device integrating capacitive touch and resistive touch, the device comprising a first sensing layer, a second sensing layer, and a processing unit, wherein the first sensing layer comprises a plurality of sensing units, and the second sensing layer comprises a plurality of electrodes, the operation method comprising:
the processing unit charging the first sensing layer when the device is in a resistive touch mode;
the processing unit detecting resistance variation of the plurality of electrodes;
the processing unit determining a position of at least one second touch point according to the resistance variation of the plurality of electrodes; and
the processing unit generating at least one second corresponding control signal according to the position of the at least one second touch point.

14. An operation method of a device integrating capacitive touch and resistive touch, the device comprising a first sensing layer, a second sensing layer, and a processing unit, wherein the first sensing layer comprises a plurality of sensing units, and the second sensing layer comprises a plurality of electrodes, the operation method comprising:
the processing unit charging the second sensing layer when the device is in a resistive touch mode;
the processing unit detecting resistance variation of the plurality of sensing units;
the processing unit determining a position of at least one third touch point according to resistance variation of the plurality of sensing units; and
the processing unit generating at least one third corresponding control signal according to the at least one third touch point.
